(19) United States
(12) Patent Application Publication
(10) Pub. No.: US 2005/0004865 A1
(43) Pub. Date: Jan. 6, 2005

(54) Control and monetization of networking transactions

(76) Inventors: Stan Chudnovsky, Brisbane, CA (US); James P. Currier, San Francisco, CA (US); Adrian B. Darnell, San Francisco, CA (US)

Correspondence Address: PERKINS COIE LLP, P.O. BOX 2168, MENLO PARK, CA, 94026, US

(21) Appl. No.: 10/619,948

(22) Filed: Jul. 15, 2003

Related U.S. Application Data
(60) Provisional application No. 60/484,040, filed on Jul. 1, 2003.

(51) Int. Cl. G06F 17/60

(52) U.S. Cl. 705/39; 705/1

(57) ABSTRACT

The present invention teaches a variety of techniques and mechanisms for controlling and monetizing networking transactions among users of a computer network. At least some of these techniques and mechanisms come about as a result of several new paradigms contemplated by the present invention. One paradigm of the present invention involves monetizing user transactions as a function of relational patterns and connections between different users. Another paradigm of the present invention introduces a “virtual network” as a set of user having some predefined relational pattern. Once virtual networks are defined for a plurality of users, decisions regarding transactions can then be made based on the characteristics of the virtual network.

### CROSS-REFERENCE TO RELATED APPLICATIONS

This application claims the benefit under 35 U.S.C. sec. 119(e) of Chudnovky's U.S. Provisional Patent Application No. ______, filed Jul. 1, 2003, which application is incorporated herein by reference.

### TECHNICAL FIELD

The present invention relates generally to computer data and information systems, and more particularly to the control and monetization of networking transactions based on relational patterns between users.

### BACKGROUND

The development of technology and the explosion of users connected to the Internet has permanently changed the way people communicate with each other. Networking databases can provide a user access to direct contacts to those family, friends and acquaintances the user has successfully added. A direct contact may be described as a contact separated from the user by one degree of freedom. Today it is possible to imagine a scenario where that user can access not just direct contacts, but contacts of direct contacts, i.e., other Internet users who are separated by more than one degree of freedom.

Tools exist for establishing relational or contact paths enabling a user to connect to other parties separated by more than one degree of freedom. In certain cases, these teachings provide the user a specific indication of the relational path that connects the user to the party. Some of these tools have even provided unsophisticated techniques for monetizing transactions between users.

Existing technology fails to fully take advantage of the wealth of information available or potentially available through a properly populated and managed networking database. For example, in prior art schemes where relational connections are established between users, all relational connections are treated equally without reference to the degree of separation and other characteristics of the relational pattern. Likewise, there is no teaching for monetizing transactions between two users as a function of their degree of separation. What are needed are networking techniques and systems which fully utilize the relational data to implement sophisticated monetization and control strategies.

### BRIEF DESCRIPTION OF THE FIGURES

The accompanying figures illustrate embodiments of the claimed invention. In the figures:

FIG. 1 is a block diagram of a networking database data structure in accordance with one embodiment of the present invention;

FIG. 2 is a block diagram of a user element data structure in accordance with another embodiment of the present invention;

FIG. 3 is a block diagram of a connections data structure in accordance with yet another embodiment of the present invention;

FIG. 4 is a graphical representation of relational connections for a networking database according to one aspect of the present invention;

FIG. 5 is a populated connections database in accordance with one embodiment of the present invention;

FIG. 6 is a graphical representation of relational connections for a second networking database according to one aspect of the present invention;

FIG. 7 is a populated connections database for the second networking database of FIG. 6 in accordance with one embodiment of the present invention;

FIG. 8 is a flow chart showing a first method for controlling and monetizing transactions according to another aspect of the present invention;

FIG. 9 is a flow chart showing a method for adding parties to a networking database in accordance with one embodiment of the present invention,

FIG. 10 is a flow chart illustrating another method for controlling and monetizing transactions among users of a database according to still another aspect of the present invention; and

FIG. 11 is a flow chart illustrating yet another method for controlling and monetizing transactions among computer users in accordance with yet another embodiment of the present invention.

Any headings used herein are for convenience only and do not affect the scope or meaning of the claimed invention.

### SUMMARY OF THE INVENTION

The present invention teaches a variety of techniques and mechanisms for controlling and monetizing networking transactions among users of a computer network. At least some of these techniques and mechanisms come about as a result of several new paradigms contemplated by the present invention. One paradigm of the present invention involves monetizing user transactions as a function of relational patterns and connections between different users. Another paradigm of the present invention introduces a “virtual network” as a set of user having some predefined relational pattern. Once virtual networks are defined for a plurality of users, decisions regarding transactions can then be made based on the characteristics of the virtual network.

### DETAILED DESCRIPTION OF THE ILLUSTRATED EMBODIMENTS

The present invention teaches a variety of techniques and mechanisms for controlling and monetizing networking transactions among users of a computer network. At least some of these techniques and mechanisms come about as a result of several new paradigms contemplated by the present invention. One paradigm of the present invention involves monetizing user transactions as a function of relational patterns and connections between different users. Another paradigm of the present invention introduces a “virtual network” as a set of user having some predefined relational pattern. Once virtual networks are defined for a plurality of users, decisions regarding transactions can then be made based on the characteristics of the virtual network.

The present invention defines a “networking transaction” broadly as any interaction which a unique computer user might contemplate performing. Thus networking transactions include communications of all types with other computer users, joining a networking database, inviting others to join a networking database, adding other users or parties to a users set of friends or contacts database, forming relational connections with other users, joining a community of other computer users having some common characteristic, creating a community open to other computer users having some common characteristic, inviting other users into a community, etc.

The computer network contemplated by the present invention can be a closed network, a wide area network, a local area network, a World Wide Web such as the Internet, etc. The present invention also teaches the use of networking databases populated with users and supporting viral growth. Such networking database are well suited for providing a structure wherein the control and monetization techniques of the present invention are implemented. However, the control and monetization techniques of the present invention can be accomplished with direct use of a networking database, as will be described below.

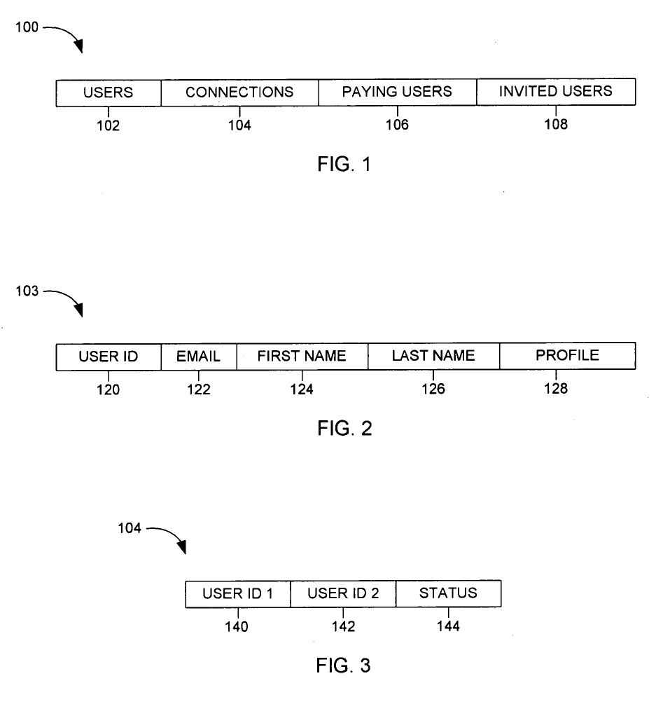

FIGS. 1-3 are block diagrams of several data structures suitable for use in managing networking databases of the present invention. In light of the present teaching, those skilled in the art will readily ascertain how to select specific implementations and variable types for the data structures of FIGS. 1-3. The networking database supported by FIG. 3 is a database populated with a plurality of uniquely identified users, together with data suitable to aid the control and monetization of requested transactions. Typically this data includes at least some of the following: user profile data, monetization data, relational information among the plurality of users, and transaction rules. Networking databases of the present invention enable control, implementation and monetization of transactions requested by the populating users. These transactions may involve parties that are not members of the networking database including those parties that have been invited to join the networking database.

FIG. 1 illustrates a networking database 100 in accordance with one embodiment of the present invention. The networking database 100 includes a users data structure 102, a connections data structure 104, a paying users data structure 106, and an invited users data structure 108. The users data structure 102 is suitable for storing data characterizing and uniquely identifying the users populating the networking database 100. The connections database structure 104 is suitable for storing data defining and/or characterizing relational connections between the users populating the networking database 100.

With further reference to FIG. 1, the paying users data structure 106 is suitable for storing data related to user ability to monetize transactions. Data possibly found in paying users data structure 106 includes membership status (e.g., paying versus nonpaying), user subscription level, user account and credit information, etc. The invited users data structure 108 is suitable for storing data related to parties that have neither accepted nor rejected a pending invitation to join the networking database 100.

FIG. 2 illustrates a user element 103 suitable for use as a single element of an array of user elements forming a users data structure 102 in accordance with one embodiment of the present invention. The user element 103 includes user identification data 120, user email data 122, user first name data 124, user last name data 126, and user profile data 128. Once populated with the necessary data, the user element 103 corresponds to a unique specific user. The user identification data 120 is preferably a unique identification number selected by or assigned to the specific user. The intended contents of email data 122, first name data 124, last name data 126, will all be self-evident to those skilled in the art, and may be provided directly by the specific user or from any valid source. In certain embodiments, the user profile data 128 includes a privacy indication for data therein. The privacy indication can also be a function of the relational connection. E.g., only users having one degree of separation are entitled to search certain data, while the public may search other types of data.

Turning to FIG. 3, one embodiment of the present invention teaches a connections data structure 104 being an array having a column of user id 1 elements 140, a column of user id 2 elements 142, and a column of connection status elements 144. When populated with data, a user id 1 element 140 contains a unique identifier for a first user present in the networking database 100, and a user id 2 element 142 contains a unique identifier for a second user present in the networking database 100. A corresponding connection status element 144 contains a status of a connection between the first and second users. The present invention contemplate a variety of connection status types including active, requested, uni-directional, conditional, etc.

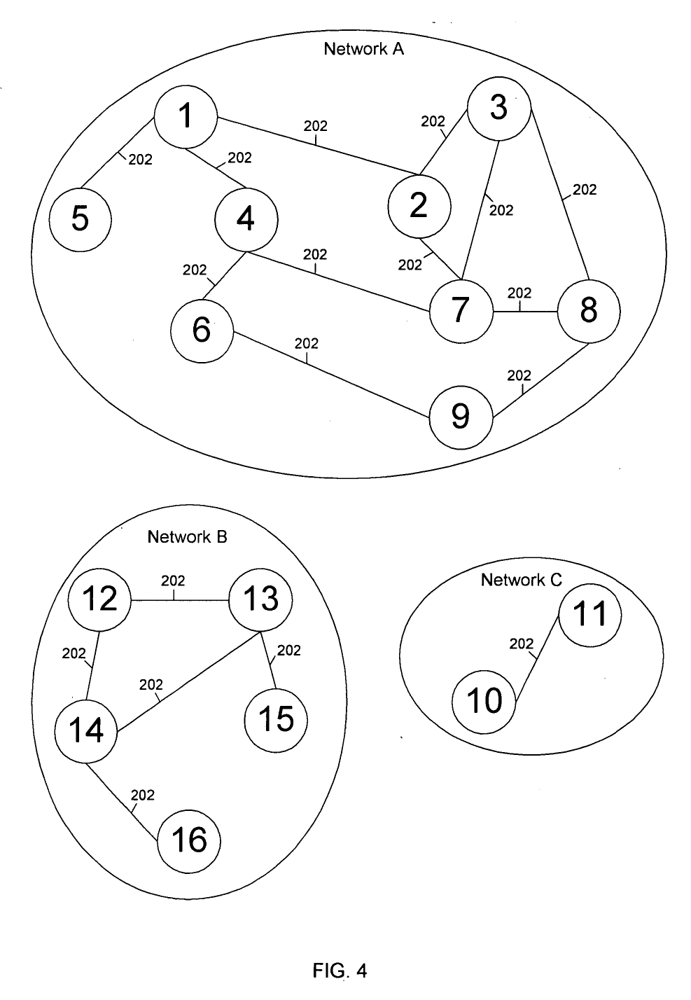

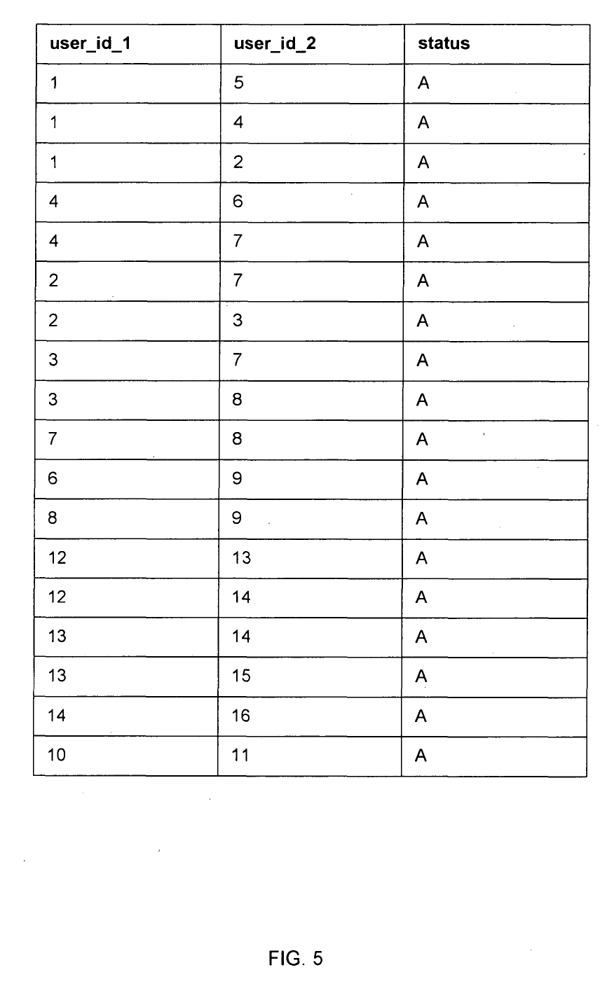

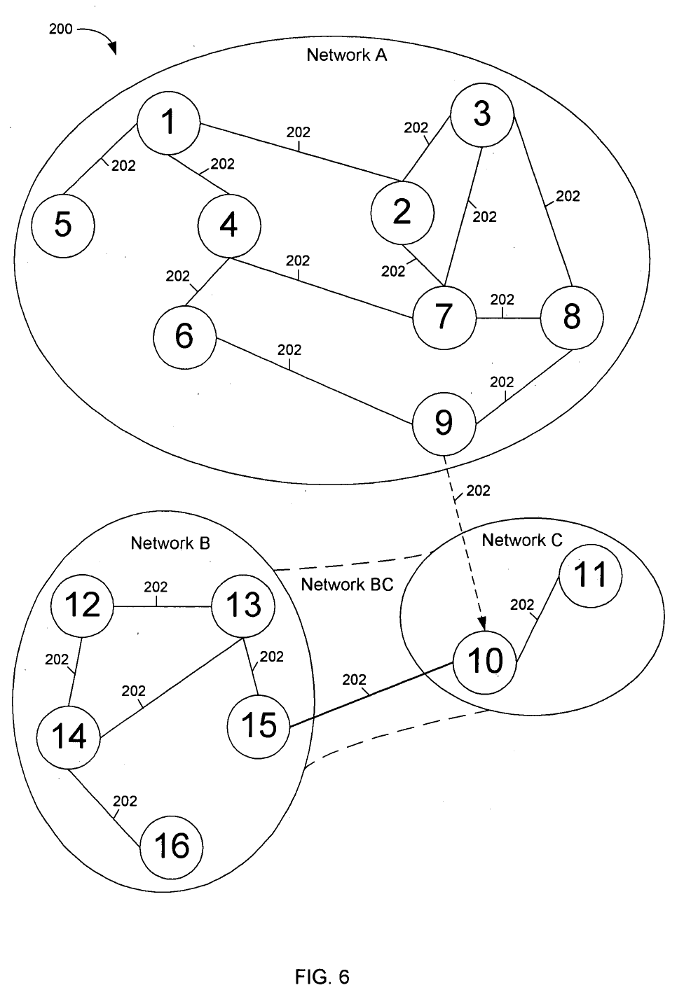

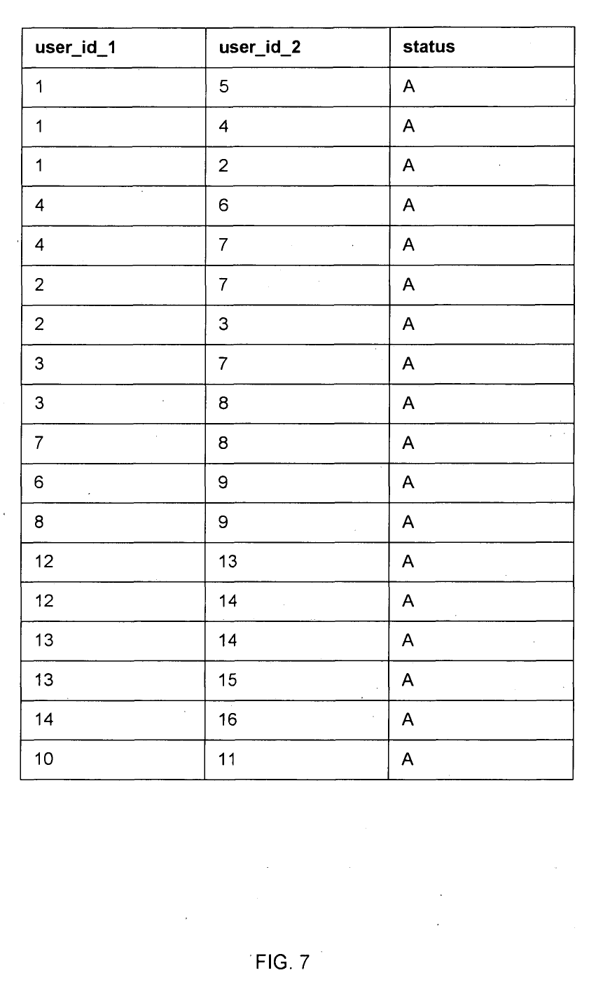

FIGS. 4 and 6 are graphical illustrations of relational connections 202 for a specific networking database 200 in two different fixed states. FIGS. 5 and 7 show in table format connections data structure 103 for the fixed states of FIGS. 4 and 6 respectively.

Referring to FIGS. 4 and 5, the networking database 200 is populated with a plurality of users 1-16 having relational connections 202. FIG. 5 shows a populated connections data structure 103 representing the relational connections 202 of FIG. 4. As indicated by the status column, all the relational connections 202 are set at a status “A” representing that each relational connection 202 is active and available for supporting a transaction between the connected users.

Those skilled in the art will readily understand how certain relational connections can be viewed as a degree of separation between two users. By way of example, users 4 and 5 have two degrees of separation as they are connected by two relational connections 202 through user 1. In preferred embodiments, the relational path used to connect two users will be selected as the relational path with the least degrees of separation. Those users that have no connecting relational path have an undefined degree of separation.

In certain embodiments, the relational connections 202 are direct one degree of freedom relational connections between two users. However, those skilled in the art will appreciate that the relational connections 202 can take a variety of suitable forms. It is contemplated that a relational connection may correspond to a one way communication channel. For example, a first user may grant email access to all users in the networking database, however the first user could only send an email to those users that have granted the first user this right, either directly or indirectly through a series of suitable relational connections 202. Furthermore, the present invention contemplates supporting different types of relational connections within the same networking database 100.

With further reference to FIG. 4, the users 1-16 are organized into virtual networks A, B, and C. A “virtual network” is defined as a set of all users within a networking database that have a relational connection or a defined degree of separation and are thus immediately available for certain transactions. The paradigm of virtual networks enables transaction control not previously available. Certain embodiments of the present invention contemplate limiting transactions the non-member parties can perform with members of a virtual network. This enables, e.g., elimination of spam email without resort to ineffective filters and other failed prior techniques. As will be appreciated, organization of users into virtual networks can be performed in real time during execution of transactions, or can be performed prior and the data stored within the networking database and updated periodically or upon any change. Virtual networks and their uses will be described in more detail below.

The virtual networks A, B, and C shown in FIG. 5 are of the type defined by a relational connection such as email contact, etc. However, virtual networks can be formed based on a variety of parameters such as those found in the user profile. For example, users may indicate their favorite movie genre, age of children, etc. Any of these profile parameters may be used to group users into virtual networks. This also enables users to be members of more than one different virtual network, where each virtual network formed based on a different type of user profile parameter.

FIG. 6 illustrates the networking database 200 after a state transition has occurred. Specifically, users 10 and 15 have established a relational connection 202, and users 9 and 10 have a requested relational connection 202′. The new relational connection 202 between users 10 and 15 causes virtual networks B and C to form a new virtual network BC. The requested relational connection 202′ may have been initiated by either user 9 or user 10, or may have been initiated by the system. FIG. 7 shows in table format the connections data structure 103 for the fixed state of FIG. 6.

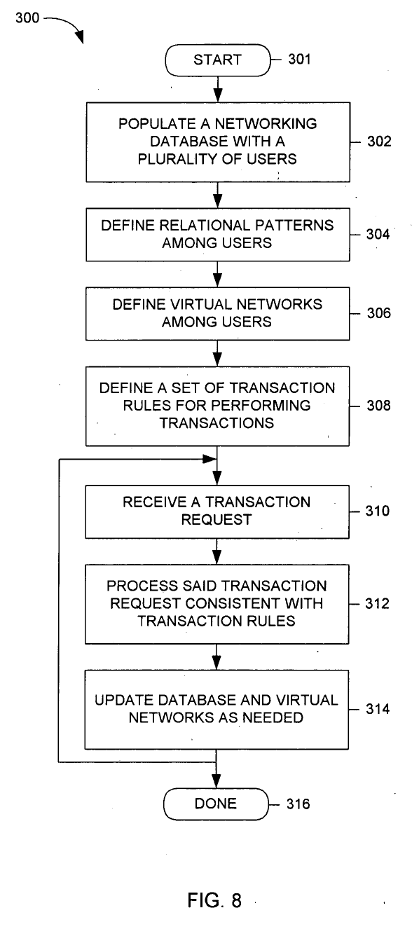

FIG. 8 is a flow chart showing a method 300 for controlling and monetizing a user requested transaction implemented within a networking database such as networking database 100 of FIG. 1. Transactions contemplated by the present invention include communication (email, instant messaging, video conferencing, voice, etc.), database searching and viewing of public profile information, requests to add parties to the networking database or to a user's set of friends, etc. Each of these transactions are analyzed to determined whether monetization is desired. Monetization includes charging a user for a transaction involving another party, with possible reference to a variety of factors such as the relational connection of the user to the party, a membership or subscription level of the user and/or party, popularity of users, etc. Other types of monetization are described throughout the specification, and the intent here is for a broad all encompassing definition to apply. In light of the present teaching, those skilled in the art will readily implement still further mechanisms for monetizing transactions.

In an initial step 301, any necessary initialization and set up procedures are performed. The initialization process may involve instantiating a database manager process upon a database server. The initialization process may involve creating and initializing a template for a networking database, or invoking for use a pre-existing networking database. As will be appreciated, the networking database may be a distributed database, and the initial step would then involve establishing any necessary communications links between the distributed portions of the database.

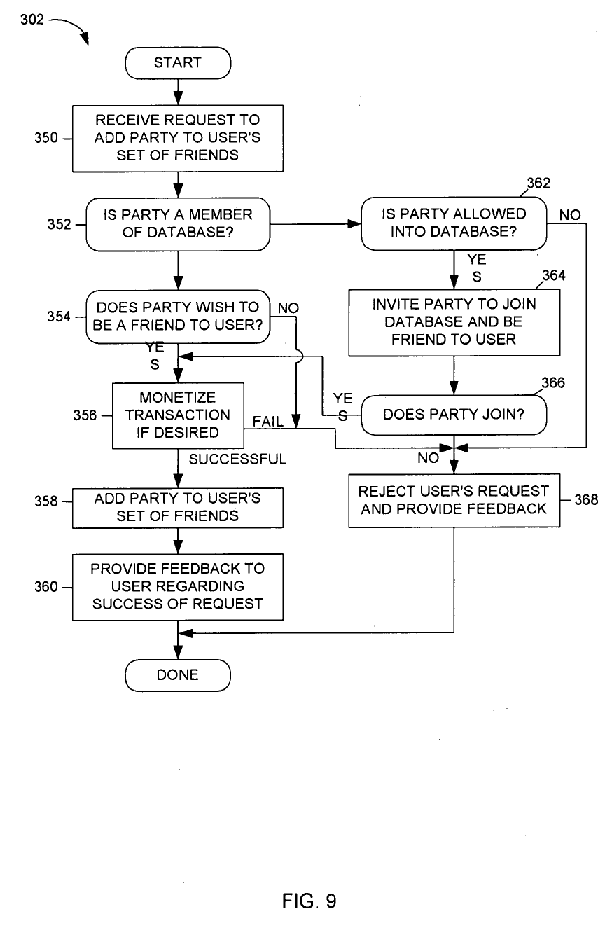

In a step 302, a networking database is populated with a plurality of users. Populating the networking database with users may involve porting in a pre-existing database of users and inserting such data into the database template, updating the pre-existing database, inviting parties to join the networking database and then including received data as desired, responding to a party's request to be added to the networking database, creating a networking database from scratch, etc. Each user provides or is assigned a unique identifier, and a minimum amount of profile data is required. One suitable method 302′ for adding a party to the networking database in response to a user request is described below in more detail with respect to FIG. 9.

A step 304 defines relational patterns among the users populating the networking database. Step 304 may include generating a connection table such as connection data structure 104 illustrated in FIGS. 3, 5 and 7, representing one degree of freedom connections among the users populating the database. Step 304 may also define more complicated relational patterns. For example, the present invention contemplates one way connections between users, and conditional or context sensitive connections between users. For example, a user may set preferences such as limiting email transactions to only those users having a one degree of separation relational connection. As another example, a user may set a preference that email transactions must cost the requesting user.

Step 304 may acquire the data necessary to define and generate the relational patterns through any suitable mechansim or technique. For example, step 304 may mine through existing data found in sources such as contact databases, history of previous email traffic, etc. Step 304 may also include users entering email address information for contacts they have a relationship with.

A next step 306 defines one or more virtual networks from the plurality of users populating the networking database. This step 306 is optional, and may be performed initially through examination of each user populating the networking database, or may be performed on a case by case basis as required to execute a transaction.

A step 308 defines a set of transaction rules for performing transactions. The present invention contemplates making a wide variety of transactions available to users in the networking database. These transactions include email, instant messaging, calendaring, data sharing, searching, auctioning, psychological profiling, dating services, community services. The set of transaction rules may include pre-existing rules taken from an outside source or invoked at initiation, or the transaction rules may be determined on the fly, and may depend upon the character of the networking database as populated. In certain embodiments, the transaction rules define how to monetize any transaction, and how to respond to requests originating from parties not found in the networking database, or transactions directed outside of the networking database.

A step 310 receives a transaction request. The received transaction request may originate from a user found in the networking database, or in certain embodiments a non-member party. The present invention also contemplates absolutely closed networking databases that do not accept transaction requests whatsoever from outside the networking database.

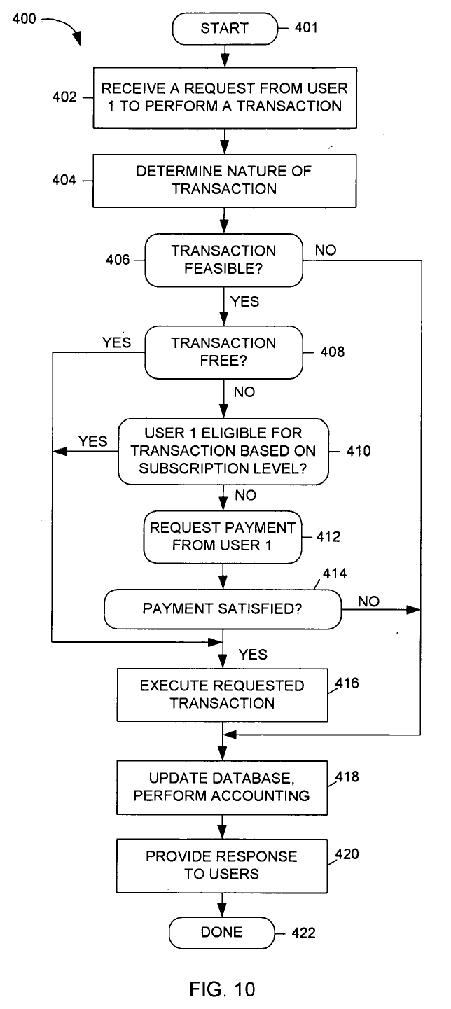

A next step 312 processes the transaction request in a manner consistent with the transaction rules and the relational patterns of the networking database. Processing a transaction request may include determining whether the requested transaction is allowed and under what circumstances, determining the presence of required circumstances such as an existing relational connection which supports the requested transaction, requiring successful monetization prior to execution or initiation of such transaction, and/or attempting to change the circumstances in order to effectuate the transaction. One possible set of rules is illustrated below within the description of method 400 of FIG. 10.

A step 314 performs any necessary record keeping resulting from the transaction request such as updating the networking database and virtual networks, as well as notifiying a database manager of certain events.

The method 300 of FIG.8 is a suitable and generic approach to implement certain aspects of the present invention. However, those skilled in the art will readily be able to adapt the principles set forth in method 300 to more narrow applications as well as to broader embodiments.

FIG. 9 is a flow chart illustrating a method 302′ suitable for responding to a specific user requesting that a party be added to the specific user's set of friends. A user's “set of friends” is defined as users found in a networking database that have a certain relational connection with the specific user. The present invention contemplates that the certain relational connection can be defined as any type or range of relational connections. For example, the certain relational connection may be defined as a direct, one degree of freedom connection. This direct connection implies that the two users are capable of performing any variety of transactions. In another embodiment, the certain relational connection may be a one way connection meaning that the specific user's friends have permission to send communications to the user, regardless of whether the specific user has permission to send communications to those users.

Allowing database users to add parties to their set of friends enables viral growth of the networking database. This viral growth in turn improves opportunity for transactions, and creates more opportunities for monetization of such transactions. Of course, certain embodiments of the present invention which require stricter control and privacy within the networking database will not enable or will strictly limit viral growth.

The method 302′, as with any method for allowing a user to add members to the networking database, may result from the network database managing process proactively inviting the user to add to the networking database, say for example during an initial population phase of the networking database, or when the user has recently joined the networking database. The method 302′ may be prompted by a determination that a requested transaction is not available until certain relational connections are established. Of course, the user may initiate a method 302′ during the course of updating user contacts. Those skilled in the art will recognize that these are only a few of the ways and reasons a user may attempt to add a party to their set of friends.

Turning directly to the method 302′ of FIG. 9, a step 350 receives a request from a specific user to add a party to a networking database. As mentioned above, the request of step 350 may arise in a variety of circumstances. A step 352 determines whether the party is a member of the networking database. When step 352 determines the party is present in the networking database, a step 354 determines whether the party is willing and available for inclusion in the specific user's set of friends. Certain implementations of step 354 require explicit, case by case, permission from the party. In other embodiments, a predefined variable prohibiting connections or conditionally or unconditionally enabling connections can be set by the party, or by the managing process. For example, a party may only permit inclusion in the set of friends when the user has a certain level of popularity as defined by the system. In other embodiments, step 354 evaluates a status of the party, e.g., perhaps the party is a member of the database but is delinquent on payment for services, etc. Step 354 can be skipped altogether, for the present invention contemplates schemas where all users in the networking database are entitled to add other users into their set of friends.

When step 354 determines that the party either denies permission or is not entitled to become a member of the user's set of friends, a step 368 rejects the user's request. The rejection of step 368 often includes providing some type of feedback to the requesting user regarding the failure. In certain embodiments, step 368 includes a determination of whether the requesting user can accomplish the request by taking some other action such as adding another party to the database, and then prompting the user to take such action first and then resubmit the request. For example, the party may only grant permission if the user has a relational connection to another user found in the party's set of friends. In this case, the user may be prompted to add another user with such a connection thereby enabling addition of the desired party.

When step 354 determines that the party grants permission and is entitled, a step 356 monetizes the transaction. Monetization may include charging the requesting user for adding the party to the user's set of friends, or determining if the requesting user has a subscription level allowing the transaction (e.g., nonpaying users cannot add, paying users can). The present invention contemplates embodiments that involve sharing the benefit of the monetization with the added party, and/or allowing the added party to set the cost of the transaction. Alternatively, monetization may include giving credit to the requesting user, or may simply determine that the cost to the user and the party is nothing (i.e., free!).

When monetization step 356 fails, a step 368 rejects the user's request. When monetization failure causes the rejection, step 368 often includes providing feedback regarding the nature of failure. In certain embodiments, step 368 includes a determination of whether the requesting user can accomplish the request by taking some other action such as updating credit card information or providing another valid form of payment, taking an action which results in credit being added to the user's account, etc. Step 368 may prompt the user to attend to these and resubmit the request to add the party to the user's set of friends.

When monetization step 356 succeeds, a step 358 adds the party to the user's set of friends by taking an action such as updating the connections data structure. Then a step 360 provides feedback to the requesting user regarding the success of the transaction.

Turning back to an earlier part of the flow chart not yet covered, when step 352 determines that the party is not a member of the networking database, a step 362 determines whether the party can be added to the networking database. Step 362 can be based on a variety of factors such as the identity of the party (known spammer?), whether a suitable connection can be made with the party, etc.

When step 362 determines that the party is not allowed in the database, a step 368 rejects the user's request, typically providing feedback in the process. When step 362 determines that the party is eligible to join the networking database, a step 364 invites the party to join the networking database. The process of joining typically involves obtaining data such as that necessary to populate the networking database with the party, assigning a unique user identity, monetizing the transaction as desired, etc. When the party successfully joins the networking database, control passes to monetization step 356, and on to steps 358 and 360 as described above. When the party does not join the networking database, control passes to step 368 that rejects the user's request and provides feedback to the user as desired.

FIG. 10 is a flow chart illustrating another method 400 for controlling and monetizing transactions among users of a networking database. The method 400 can be interpreted as a partial or whole implementation of the set of transaction rules described above with reference to FIG. 8, or alternatively may be interpreted as a suitable stand alone method for controlling and monetizing transactions among users of a networking database. In either case, a preliminary step 401 corresponds to all the necessary initialization steps, such as populating the networking database, which set the stage for dealing with user transaction requests.

A step 402 receives a transaction request from a specific user. The present invention contemplates a wide variety of available transactions such as email, instant messaging, video conferencing, database searching, modifying the database, dating services, job finding services, people finding services, contact lookup, etc. A step 404 determines the nature of the requested transaction. A step 406 determines whether the transaction is feasible based on a set of predefined rules. For example, the first user may request communication with a second user, in which case it must first be determined whether there is a relational connection between the first and second user sufficient to support the requested communication. Perhaps the transaction request corresponds to a search on a particular type of user profile data, and step 406 must determine whether the first user has access to such data.

In certain embodiments, when step 406 determines the requested transaction is not feasible, the method 400 proceeds to a step 418 that performs any necessary updates to the database. For example, it may be useful in certain contexts to monitor failed transactions. Then a step 420 responds to the specific user indicating that the requested transaction failed, and if desired, the response can indicate the nature of the failure.

In other embodiments, when step 406 determines that the requested transaction is not feasible, the method 400 may continue in step 406 to attempt to change the situation so that the transaction is feasible. For example, email may only be permitted among users that are members of the same virtual network. Thus a request for communication to a user outside of the specific user's network is not immediately feasible, but would be feasible should the specific user add a relational connection that includes the outside user into the same virtual network. Step 406 may prompt the specific user to take action to accomplish this, and then hold the transaction request for a period of time if during which the user succeeds in adding the outside user to the specific user's virtual network, the transaction becomes feasible and the method 400 continues rather than terminating the transaction request.

In any event, when step 406 determines that the transaction is feasible, a step 408 then determines whether the transaction is free. When the transaction is free, control passes to a step 416 which initiates the requested transaction, then a step 418 performs any necessary database updates, and then step 420 provides a response to the specific user regarding the successful initiation of the transaction. The present invention contemplates that the user may be compensated for successfully initiating certain types of transactions. For example, the specific user may be compensated for transactions resulting in another paying user joining the networking database, and/or transactions such as completing surveys, or joining another networking database, or joining a given virtual network. This compensation may take a variety of forms such as direct payment, credit for future transactions within the networking database, credit toward the purchase of goods sold by the operator of the networking database, airline miles, etc.

When step 408 determines that the transaction is not free, a step 410 determines whether the specific user is eligible to have the requested transaction completed based on a subscription level or some other characteristic of the specific user. An example rule might instruct us that email communication between users having one degree of separation is free and becomes progressively more expensive as the degree of separation between users increases. When step 410 determines that the specific user is eligible, process control passes along to step 416 that initiates execution of the requested transaction and proceeds as described above.

When step 410 determines that payment is required, a step 412 requests payment from the specific user. It will be appreciated that payment can be accomplished through a variety of mechanisms. For example, the specific user may have an account with the networking database, and step 412 debits the transaction cost from that account if funds are available. The specific user's account may have both a cash reserve, credit from past monetize transactions, or both. Certain transactions may be payable only from a cash reserve, while others may be payable from cash reserve or credit. As another example, the specific user may have a credit card on file that is automatically debited or the user may be prompted to select a credit card to pay the transactions cost.

A step 414 determines whether the transaction cost was successfully paid, and if so control passes to transaction execution step 416 and proceeds as described above with reference to initiating and executing the transaction, else the transaction request is rejected and the method 400 proceeds as described above with reference to failure.

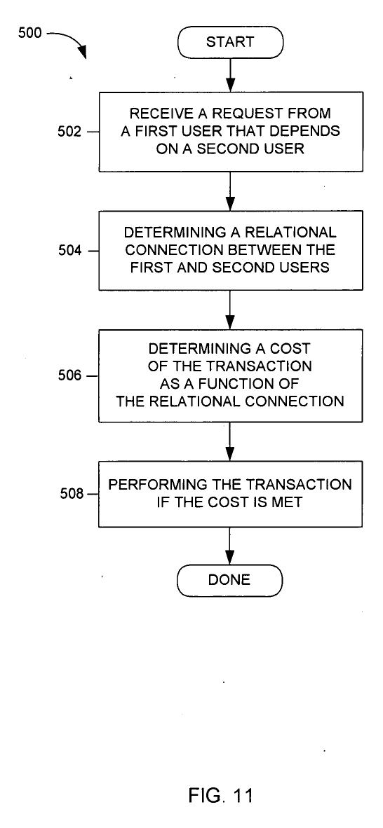

FIG. 11 illustrates another method 500 for controlling and monetizing a transaction between two users. The above discussion focused on networking transactions based on a specific networking database. However, the teachings of the present invention are not limited to networking database scenarios, but rather can be applied to any transaction between users found on a computer network. In the example of FIG. 11, method 500 focuses on monetizing transactions between two users as a function of a relational connection between the two users.

A first step 502 receives a request from a first user to perform a transaction that is dependent upon a second user. The requested transaction can be any of a variety of suitable transactions such as communication (email, etc.) with the second user, a search upon data related to the second user, etc. A next step 504 determines a relational connection between the first and second users. Step 504 contemplates both real time determination and retrieval of the relational connection information from a networking or other type of database.

After the relational connection is determined in step 504, a step 506 determines a cost of executing the transaction, the execution cost being a function of the relational connection. The method 500 does not limit how this cost is determined except that it must in some way be related to the relational connection between the two users. For example, it may that transactions between users having a one degree of separation relational connection are free. The transaction cost may increase as a function o the degrees of freedom of the relational connection. Or perhaps all email transactions are free between users that have a relational connection, but video conferencing transactions and searches are monetized as a function of the relational connection between the two users.

In any event, once the cost has been determined, the method 500 continues as a step 508 performs initiation or execution of the transaction if and when the costs are met. As described above, the cost may be met in a variety of ways, and the benefit may be shared with the second user. Certain transaction may result in benefit flowing to the first user, which benefit may take on any suitable form.

The description herein of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize.

Access to the different forms of databases and virtual networks can be controlled by any means. For example, access to a virtual network may be controlled such that only members of the virtual network may search on certain profile data associated with members of the virtual network. Alternatively, access to a virtual network may be controlled so that non-members may search or view certain profile data associated with members of the virtual network, but non-members are not allowed to engage in transactions with the members of the virtual network.

Regardless of any serial execution of the flow chart steps implied by their visual placement, those skilled in the art will recognize when such steps may be performed in parallel or in a different order, sometimes without effecting the outcome and other times in order to implement a different but related embodiment.

All of the references and U.S. patents and applications referenced herein are incorporated herein by reference. Aspects of the invention can be modified, if necessary, to employ the systems, functions and concepts of the various patents and applications described herein to provide yet further embodiments of the invention.

These and other changes can be made to the invention in light of the detailed description herein. In general, in the following claims, the terms used should not be construed to limit the invention to the specific embodiments disclosed in the specification and the claims. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

1. A computer-implemented method for controlling networking transactions among a plurality of users populating a networking database, said networking database populated with at least user identity information and relational information between said plurality of users, said method comprising:
receiving a request from a first user to perform a transaction;
determining a feasibility of said transaction based on at least a characteristic of said transaction, a characteristic associated with an identity of said first user, and said relational information;
when said transaction is feasible, monetizing said transaction including monetization possibilities such as variable pricing for said transaction and not charging for said transaction; and
after successful monetization of said transaction, initiating execution of said transaction.

2. A computer-implemented method as recited in claim 1, wherein execution of said request requires communication with a second party.

3. A computer-implemented method as recited in claim 2, wherein when said second party is not one of said plurality of users in said networking database, said transaction feasibility is defined as negative.

4. A computer-implemented method as recited in claim 3, further including responding to said first user that said transaction is not feasible.

5. A computer-implemented method as recited in claim 2, wherein when said second party is not one of said plurality of users in said networking database, the method further comprises attempting to add said second party into said plurality of users in said networking database whereby when said second party is successfully added to said networking database said transaction becomes feasible.

6. A computer-implemented method as recited in claim 1, wherein said second party is a second user present in said networking database, and said first and second users are members of a first virtual network defined by a defined degree of separation.

7. A computer-implemented method as recited in claim 1, wherein said first and second users are members of a first virtual network defined by a user profile parameter said first and second users have in common.

8. A computer-implemented method as recited in claim 6, wherein said first and second users are members of a second virtual network defined by a user profile parameter said first and second users have in common.

9. A computer-implemented method as recited in claim 6, wherein monetizing said transaction includes first determining a cost of executing transaction based on one or more factors including at least said defined degree of separation.

10. A computer-implemented method as recited in claim 9, wherein said transaction is free when said defined degree of separation is zero or one, and said cost to said first user of execution of said transaction is a function of at least said defined degree of separation.

11. A computer-implemented method as recited in claim 10, wherein said characteristic associated with an identity of said first user is a specific subscription level, and said cost to said first user is further a function of said specific subscription level.

12. A computer-implemented method as recited in claim 6, wherein said feasibility is a function of at least one characteristic of said second user.

13. A computer-implemented method as recited in claim 12, wherein said at least one characteristic of said second user is defined by said second user such that said second user can define whether said transaction is feasible.

14. A computer-implemented method as recited in claim 6, wherein said cost of said transaction is determined by at least one characteristic of said second user.

15. A computer-implemented method as recited in claim 14, wherein said at least one characteristic of said second user is a popularity of said second user and a greater popularity tends to mean a greater cost to said first user.

16. A computer-implemented method as recited in claim 13, wherein said at least one characteristic of said second user is factor defined by said second user.

17. A computer-implemented method as recited in claim 6, wherein said second user shares said cost of executing said transaction.

18. A computer-implemented method as recited in claim 6, wherein said second user benefits from said cost of executing said transaction.

19. A computer-implemented method as recited in claim 1, wherein said monetization includes a possibility of said user being paid for a successful execution of said transaction.

20. A computer-implemented method as recited in claim 19, wherein said transaction includes adding new users to said networking database.

21. A computer-implemented method for controlling and monetizing transactions between users of a computer network, the method comprising:
receiving a request from a first user to initiate a transaction that is dependent upon a second user;
determining a relational connection between said first user and said second user; and
determining a cost of executing said requested transaction, said execution cost being a function of said relational connection.

22. A computer-implemented method as recited in claim 21, wherein:
the requested transaction is transmission of an email message from said first user to said second user;
the cost of transmitting said email message from said first user to said second user is free when said first user and said second user have a one degree of separation relational connection; and
the cost of transmitting said email message from said first user to said second user increases as a function of a degree of separation of said relational connection;

23. A computer-implemented method as recited in claim 22, wherein said increasing function has a maximum cost.

24. A computer-implemented method as recited in claim 21, further comprising initiating execution of the requested transaction if the cost of execution is met.

25. A computer-implemented method for controlling transactions among a plurality of parties, said computer-implemented method comprising:
populating a database with a plurality of users, said database storing at least user identity information and relational information between said plurality of users:
organizing one or more virtual networks from said plurality of users;
defining a set of transaction rules for determining how to implement transactions among said plurality of parties, said set of transaction rules including rules which are decided based upon data represented in said one or more virtual networks;
receiving a request from a first party to execute a transaction with a second party, and
processing said transaction request in a manner consistent with said set of transaction rules.

26. A computer implemented method as recited in claim 25, wherein said act of populating a database includes:
for said plurality of users, associating with each specific user a set of friends, wherein a friend is a one of said plurality of users that is connected to said specific user by one degree of separation.

27. A computer implemented method as recited in claim 26, wherein said associating with each specific user a set of friends includes:
receiving a request from said specific user to add a specific party to said set of friends;
determining whether said specific party is found in said plurality of users;
adding said specific party to said set of friends based upon at least said specific party being found in said plurality of users and said specific party granting permission; and
rejecting said request to add said specific party to said set of friends.

28. A computer implemented method as recited in claim 27, wherein said step of populating said database further includes monetizing the creation of said set of friends.

29. A computer implemented method as recited in claim 28, wherein said monetizing during populating includes granting said specific user a credit for each member added to said set of friends.

30. A computer implemented method as recited in claim 25, wherein:
when said specific party is not found in said plurality of users, attempting to add said specific party to said set of users; and
when said specific party is found in said plurality of users, making permission of said specific party a necessary condition of adding said specific party to said set of friends.

31. A computer implemented method as recited in claim 25, wherein when said request is not enabled, denying said request absolutely.

32. A computer-implemented method as recited in claim 25, wherein when said request is not enabled, and said first party is a member of said plurality of users, inviting said second party to join a virtual network of which said first party is a member.

33. A computer-implemented method for controlling transactions among a plurality of parties, said computer-implemented method comprising:
populating a database with a plurality of users, said database storing at least user identity information, relational information between said plurality of users, and profile data for said plurality of users:
organizing one or more virtual networks from said plurality of users;
receiving a request from a first party to search said profile data; and
performing said search when said first party is a member of said database and said profile data has not been made private.

34. A computer implemented method as recited in claim 33, further comprising:
performing said search only on profile data made public.

35. A computer-implemented method for controlling email transactions among a plurality of users, said computer implemented method comprising:
forming at least one virtual network from a plurality of users, the at least one virtual network being formed of member users, said member users consisting of all of said plurality of users that have a common predefined characteristic;
receiving from a specific party an email communication intended for delivery to a specific member user,
determining whether said specific party is a member of said virtual network; and
prohibiting delivery of said email communication when said specific party is not a member of said virtual network.

36. A computer-implemented method as recited in claim 35, wherein said common predefined characteristic is a relational connection.

37. A computer-implemented method as recited in claim 35, wherein said common predefined characteristic is a user profile characteristic.

38. A computer-implemented method as recited in claim 35 further comprising:
storing a prohibited email without forwarding said prohibiting email to said specific user.

39. A computer-implemented method as recited in claim 38 further comprising:
making said email accesible to said specific user at the discretion of said specific user.

40. A computer-implemented method as recited in claim 39 further comprising:
notifying said specific user of receipt of said prohibited email communication.

41. A computer-implemented method as recited in claim 35 further comprising:
notifying said specific party of a delivery failure regarding said email communication.

42. A computer-implemented method as recited in claim 35 further comprising:
delivering said email communication when said specific party is a member of said virtual network; and
monetizing delivery of said email communication.

43. A computer database suitable for enabling transactions between a plurality of parties including a plurality of users, said computer database comprising:
unique identity information for each of said plurality of users;
relational information associated with each of said plurality of users, said relational information useful for determining whether any two users have a connection enabling at least one type of transaction between said two users, and said relational information useful for determining a degree of separation between said two users when said two users have said connection; and
virtual network information associated with each of said plurality of users, virtual network information including an identity of a virtual network of which each specific user is a member, members of each virtual network consisting of all users having a connection enabling a transaction.

44. A computer system suitable for operating as a server computer, said computer system comprising:
transient memory such as random access memory (RAM);
persistent memory such as a hard disk;
a central processing unit (CPU);
a networking device;
a databus coupling said transient memory, said persistent memory, said CPU, and said networking device;
a networking database stored on said computer system, said networking database populated with a plurality of users and at least data representing relational connections between said plurality of users;
a networking database process instantiated on said computer system, said process operable to receive transaction requests from said users, and monetize and execute said transaction requests based upon said data representing relational connections between said plurality of users.

45. A computer readable medium storing executable instructions for controlling networking transactions among a plurality of users populating a networking database, said networking database populated with at least user identity information and relational information between said plurality of users, said executable instructions comprising:
receiving a request from a first user to perform a transaction;
determining a feasibility of said transaction based on at least a characteristic of said transaction, a characteristic associated with an identity of said first user, and said relational information;
when said transaction is feasible, monetizing said transaction including monetization possibilities such as variable pricing for said transaction and not charging for said transaction; and
after successful monetization of said transaction, initiating execution of said transaction.
